(19) United States
(12) Patent Application Publication
(10) Pub. No.: US 2016/0094679 A1
(43) Pub. Date: Mar. 31, 2016

(54) ELECTRONIC DEVICE, METHOD OF CONTROLLING SAME, AND RECORDING MEDIUM

(71) Applicant: Samsung Electronics Co., Ltd., Gyeonggi-do (KR)

(72) Inventors: Woo-Yong LEE, Gyeonggi-do (KR); Jung-Eun LEE, Gyeonggi-do (KR)

(21) Appl. No.: 14/624,819

(22) Filed: Feb. 18, 2015

(30) Foreign Application Priority Data
Sep. 26, 2014 (KR) 10-2014-0129555

(51) Int. Cl. H04L 29/08

(52) U.S. Cl. CPC H04L 67/32; H04L 67/10

(57) ABSTRACT

An electronic device and method for controlling the same are disclosed herein. The electronic device may include a processor, a camera and a display. The processor may be configured to execute a camera application operating the camera and displaying a graphical user interface controlling the camera application on the display, displaying in the graphical user interface a plurality of selectable modes augmenting the camera application, in response to an input, downloading an additional selectable mode augmenting the camera application, and when the additional selectable mode is downloaded, displaying in the graphical user interface the additional selectable mode.

### CROSS-REFERENCE TO RELATED APPLICATION

This application claims priority under 35 U.S.C. §119(a) to Korean Application Serial No. 10-2014-0129555, which was filed in the Korean Intellectual Property Office on Sep. 26, 2014, the entire content of which is hereby incorporated by reference.

### TECHNICAL FIELD

The present disclosure relates to an electronic device, a method of controlling the same, and a recording medium.

### BACKGROUND

Recently, electronic devices such as smart phones operate at a high speed. In general, a high capability CPU and a high capacity memory are installed in the electronic device such as the smart phone in comparison with a mobile communication terminal according to a conventional technology.

In modern devices, applications executable in the smart phone have diversified according to the development of technology. Initial supply models of smart phones provided general functions such as, for example a camera application for taking a picture or storing a picture for a user. However, other photographing functions were not included, such as a panorama shot, a High Dynamic Range (HDR) function and the like are currently being provided to the user. That is, types of sub applications (for example, a plug in application which performs the panorama shot function) provided through a main application (for example, the camera application) are more diversified at present in comparison with the advent of smart phones.

### SUMMARY

As described above, although types of sub applications which are currently provided are diversified, users of the electronic devices actually use some specific sub applications. Accordingly, when the user executes a main application, the electronic device loads even sub application/applications which the user does not use, thereby increasing unnecessary data throughput and memory occupancy.

In one aspect of this disclosure, a method of controlling an electronic device is disclosed, the method including executing a first application by a processor of the electronic device, receiving a request for downloading a secondary application augmenting execution of the first application, and downloading the second application according to the request.

In another aspect of this disclosure, a method of controlling an electronic device is disclosed, the method including executing a first application by a process of the electronic device receiving a request for executing a second application executed in connection with the first application, detecting an attribute of a selected second application, and executing the selected second application based on the determined attribute.

In another aspect of this disclosure, an electronic device is disclosed, including a display, a camera, and a processor. The processor is configured to execute a camera application operating the camera and displaying a graphical user interface controlling the camera application on the display, displaying in the graphical user interface a plurality of selectable modes augmenting the camera application, in response to an input, downloading an additional selectable mode augmenting the camera application, and when the additional selectable mode is downloaded, displaying in the graphical user interface the additional selectable mode.

In another aspect of this disclosure, an electronic device is disclosed, including a processor for executing a first application by a process of the electronic device, receiving a request for executing a second application executed in connection with the first application, detecting an attribute of a selected second application, and executing the selected second application based on the determined attribute.

It will be apparent to those skilled in the art that the present disclosure is not limited to those mentioned above.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 illustrates an example network environment including an electronic device according to various embodiments of the present disclosure;

FIG. 2 is a block diagram illustrating an example application management module of an electronic device according to various embodiments of the present disclosure;

FIG. 3A, FIG. 3B, FIG. 3C, FIG. 3D and FIG. 3E illustrate an example operation of downloading a second application according to various embodiments of the present disclosure;

FIG. 3F is a flowchart for one embodiment of the example operation as illustrated in FIGS. 3A to 3E;

FIG. 4A, FIG. 4B, FIG. 4C, FIG. 4D and FIG. 4E illustrate an example operation of executing a second application according to various embodiments of the present disclosure;

FIG. 4F is a flowchart for one embodiment of the example operation as illustrated in FIGS. 4A to 4E;

FIG. 5 is a block diagram illustrating an example first application and second application according to various embodiments of the present disclosure;

FIG. 6 illustrates example signal flow according to various embodiments of the present disclosure; and

FIG. 7 is a block diagram illustrating an example electronic according to various embodiments of the present disclosure.

### DETAILED DESCRIPTION

Hereinafter, various embodiments of the present disclosure will be described with reference to the accompanying drawings. The present disclosure may be modified in various forms and include various embodiments, but specific examples are illustrated in the drawings and described in the description. However, the description is not intended to limit the present disclosure to the specific embodiments, and it shall be appreciated that all the changes, equivalents and substitutions belonging to the idea and technical scope of the present disclosure are included in the present disclosure. In the description of the drawings, identical or similar reference numerals are used to designate identical or similar elements.

The term “include” or “may include” refers to the existence of a corresponding disclosed function, operation or component which can be used in various embodiments of the present disclosure and does not limit one or more additional functions, operations, or components. In the present disclosure, the terms such as “include” or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

The expression “1”, “2”, “first”, or “second” used in various embodiments of the present disclosure may modify various components of various embodiments but does not limit the corresponding components. For example, the above expressions do not limit the sequence and/or importance of the corresponding elements. The expressions may be used to distinguish a component element from another component element. For example, a first user device and a second user device indicate different user devices although both of them are user devices. For example, without departing from the scope of the present disclosure, a first component element may be named a second component element. Similarly, the second component element also may be named the first component element.

It should be noted that if it is described that one component element is “coupled” or “connected” to another component element, the first component element may be directly coupled or connected to the second component, and a third component element may be “coupled” or “connected” between the first and second component elements. Conversely, when one component element is “directly coupled” or “directly connected” to another component element, it may be construed that a third component element does not exist between the first component element and the second component element.

The terms in various embodiments of the present disclosure are used to describe a specific embodiment, and are not intended to limit the present disclosure. As used herein, the singular forms are intended to include the plural forms as well, unless the context clearly indicates otherwise.

Unless defined differently, all terms used herein, which include technical terminologies or scientific terminologies, have the same meaning as a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

Electronic devices according to various embodiments of the present disclosure may be devices adopting a communication function. For example, the electronic devices may include at least one of smart phones, tablet personal computers (PCs), mobile phones, video phones, e-book readers, desktop PCs, laptop PCs, netbook computers, personal digital assistants (PDAs), portable multimedia players (PMPs), MP3 players, mobile medical devices, cameras, wearable devices (e.g., head-mounted-devices or HMDs such as electronic glasses), electronic clothes, electronic bracelets, electronic necklaces, electronic appcessories, electronic tattoos, or smart watches.

According to an embodiment, an electronic device may be a smart home appliance with a communication function. The smart home appliance as an example of the electronic device may include at least one of a television, a Digital Video Disk (DVD) player, an audio, a refrigerator, an air conditioner, a vacuum cleaner, an oven, a microwave oven, a washing machine, an air cleaner, a set-top box, a TV box (e.g., Samsung HomeSync™, Apple TV™, or Google TV™), a game console, an electronic dictionary, an electronic key, a camcorder, or an electronic picture frame.

According to some embodiments, the electronic device may include at least one of various medical appliances (e.g., magnetic resonance angiography (MRA), magnetic resonance imaging (MRI), computed tomography (CT), and ultrasonic machines), navigation equipment, a global positioning system (GPS) receiver, an event data recorder (EDR), a flight data recorder (FDR), automotive infotainment device, electronic equipment for ships (e.g., ship navigation equipment and a gyrocompass), avionics, security equipment, a vehicle head unit, an industrial or home robot, an automatic teller machine (ATM) of a banking system, or a point of sales (POS) of a shop.

According to another embodiment, the electronic devices may include at least one of furniture or a part of a building/structure having a communication function, electronic boards, electronic signature receiving devices, projectors, or various measuring equipment (e.g., equipment for a water supply, an electricity, gases or radio waves). An electronic device according to various embodiments of the present disclosure may be a combination of one or more of above described various devices. Also, an electronic device according to various embodiments of the present disclosure may be a flexible device. Also, an electronic device according to various embodiments of the present disclosure is not limited to the above described devices.

Hereinafter, an electronic device according to various embodiments of the present disclosure will be described with reference to the accompanying drawings. The term “user” used in various embodiments may refer to a person who uses an electronic device or a device (for example, an artificial intelligence electronic device) that uses an electronic device.

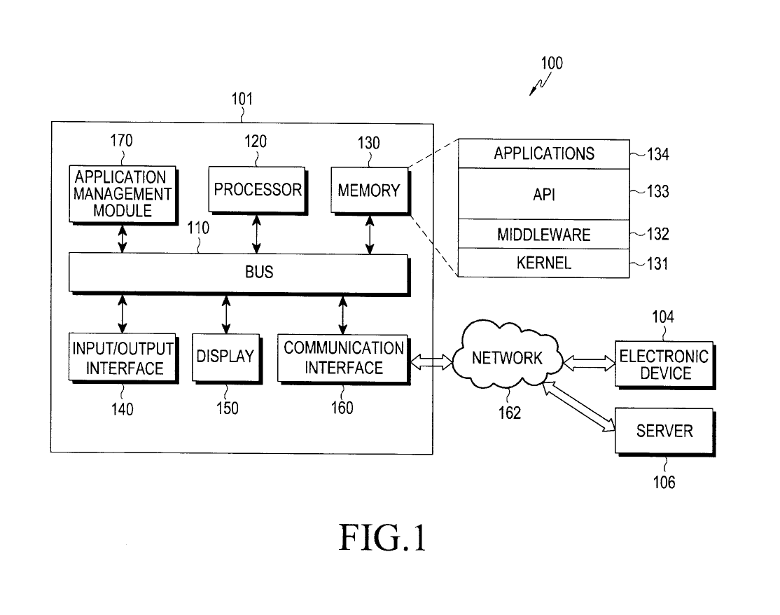

FIG. 1 illustrates an example network environment including an electronic device according to various embodiments of the present disclosure.

Referring to FIG. 1, the electronic device 101 may include a bus 110, a processor 120, a memory 130, an input/output interface 140, a display 150, a communication interface 160, and an application management module 170.

The bus 110 may be a circuit to connect the above-described components with each other and to transfer communication (for example, control messages) between the above-described components.

The processor 120 may receive instructions from the above-described components (for example, the memory 130, the input/output interface 140, the display 150, the communication interface 160, the application management module 170 or the like) through, for example, the bus 110, then decode the received instructions, and perform calculation or data processing according to the decoded instructions.

The memory 130 may store instructions or data received from the processor 120 or other components (for example, the input/output interface 140, the display 150, the communication interface 160, the application management module 170 or the like) or generated by the processor 120 or other components. The memory 130 may include programming modules such as, for example, a kernel 131, middleware 132, an Application Programming Interface (API) 133, or applications 134. Each of the programming modules described above may be formed of software, firmware, and hardware, or a combination thereof.

The kernel 131 may control or manage system resources (for example, the bus 110, the processor 120, the memory 130 or the like) which are used for performing operations or functions implemented by other programming modules, for example, the middleware 132, the API 133 or the applications 134. Furthermore, the kernel 131 may provide an interface through which the middleware 132, the API 133, or the applications 134 may access individual component elements of the electronic device 101 to control or manage them.

The middleware 132 may serve as an intermediary such that the API 133 or the applications 134 communicate with the kernel 131 to transmit/receive data. Further, in relation to requests for tasks received from the application 134, the middleware 132 may control (for example, scheduling or load-balancing) the requests for the operations by using, for example, a method of determining a sequence for using system resources (for example, the bus 110, the processor 120, the memory 130, or the like) of the electronic device 101 with respect to at least one application among the applications 134.

The API 133 is an interface by which the applications 134 control functions provided from the kernel 131 or the middleware 132, and may include, for example, at least one interface or function (for example, instructions) for file control, window control, image processing, or text control.

According to various embodiments, the applications 134 may include a Short Message Service (SMS)/Multimedia Message Service (MMS) application, an e-mail application, a calendar application, an alarm application, a health care application (for example, an application for measuring an amount of exercise or blood sugar), and an environmental information application (for example, an application for providing information on atmospheric pressure, humidity, temperature, and the like). Additionally or alternately, the applications 134 may be an application related to an information exchange between the electronic device 101 and an external electronic device (for example, an electronic device 104). The application related to the information exchange may include, for example, a notification relay application for transmitting specific information to the external electronic device, or a device management application for managing the external electronic device.

For example, the notification relay application may include a function of transferring notification information generated in other applications (for example, the SMS/MMS application, the e-mail application, the health care application, or the environmental information application) of the electronic device 101 to the external electronic device (for example, the electronic device 104). Additionally or alternately, the notification relay application may, for example, receive notification information from the external electronic device (for example, the electronic device 104), and may provide the received notification information to a user. The device management application may manage (for example, install, delete, or update), for example, at least some functions (for example, turning external electronic device (or some elements) on or off, or adjusting the brightness (or resolution) of a display) of external electronic device (for example, the electronic device 104) that communicates with the electronic device 101, applications performed in the external electronic device, or services (for example, a phone call service, or a messaging service) provided in the external electronic device.

According to various embodiments, the applications 134 may include applications, which are designated according to the property (for example, the type of electronic device) of the external electronic device (for example, the electronic device 104). For example, in a case where the external electronic device is an MP3 player, the applications 134 may include an application related to the reproduction of music.

Similarly, when the external electronic device is a mobile medical device, the application2 134 may include an application related to health care. According to an embodiment, the applications 134 may include at least one of an application designated for the electronic device 101 or an application received from external electronic devices (for example, a server 106, or the electronic device 104).

The input/output interface 140 may transfer instructions or data input from a user through an input/output device (for example, a sensor, a keyboard, or a touch screen) to the processor 120, the memory 130, the communication interface 160, or the application management module 170 through, for example, the bus 110. For example, the input/output interface 140 may provide the processor 120 with data for a user's touch which is input through the touch screen. Further, through the input/output devices (for example, speakers or displays), the input/output interface 140 may output instructions or data received from the processor 120, the memory 130, the communication interface 160, or the application management module 170 through, for example, the bus 110. For example, the input/output interface 140 may output voice data processed through the processor 120 to a user through a speaker.

The display 150 may display various pieces of information (for example, multimedia data or text data) to a user.

The communication interface 160 may connect communication between the electronic device 101 and the external electronic device (for example, the electronic device 104 or the server 106). For example, the communication interface 160 may be connected to a network 162 through wireless or wired communication to communicate with the external device. The wireless communication may include at least one of, for example, Wi-Fi, Bluetooth (BT), Near Field Communication (NFC), Global Positioning System (GPS) and cellular communication (for example, Long Term Evolution (LTE), LTE-A, Code Division Multiple Access (CDMA), Wideband CDMA (WCDMA), Universal Mobile Telecommunication System (UMTS), Wireless Broadband (WiBro), Global System for Mobile communication (GSM), and the like the like). The wired communication may include at least one of, for example, a Universal Serial Bus (USB), a High Definition Multimedia Interface (HDMI), Recommended Standard 232 (RS-232), or a Plain Old Telephone Service (POTS).

According to an embodiment, the network 162 may be a telecommunication network. The communication network may include at least one of a computer network, the Internet, the Internet of things, or a telephone network. According to one embodiment, a protocol (for example, a transport lay protocol, data link layer protocol, or a physical layer protocol) for communication between the electronic device 101 and the external device may be supported by at least one of the applications 134, the application programming interface 133, the middleware 132, the kernel 131, or the communication interface 160.

The application management module 170 may perform, for example, an operation of executing a first application which can be executed in the electronic device, an operation of receiving a request for downloading a second application executed in connection to the first application, and an operation of downloading the second application according to the request.

Alternatively, the application management module 170 may perform, for example, an operation of executing the first application which is executed in the first electronic device, an operation of receiving a request for executing the second application which is executed in connection with the first application, an operation of determining an attribute of the selected second application, and an operation of executing the selected second application based on the determined attribute.

Function/Functions or operation/operations performed by the application management module 170 may be configured to be performed by, for example, the processor 120 according to various embodiments. A more detailed description of the application management module 170 will be described below.

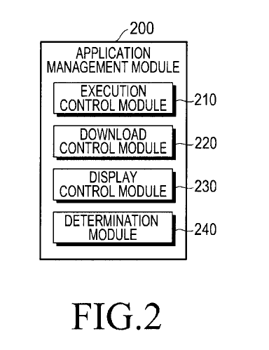

FIG. 2 is a block diagram illustrating an example application management module of an electronic device according to various embodiments of the present disclosure.

Referring to FIG. 2, an application management module 200 according to various embodiments of the present disclosure may include an execution control module 210, a download control module 220, a display control module 230, and a determination module 240.

The execution control module 210 may control the electronic device (for example, the electronic device 101) to execute a first application (for example, a camera application) which can be executed in the electronic device according to an execution request by the user. The “first application” may be referred to as a “main application” or a “parent application” according to various embodiments. Further, a “second application” may be referred to as a “sub application”, a “plug-in application”, or a “child application” according to various embodiments.

The download control module 220 may perform an operation of receiving a request for downloading the second application which is executed in connection with the first application, and an operation of downloading the second application according to the request. The download control module 220 may control the electronic device (for example, the electronic device 101) to communicate with other electronic device/electronic devices through a communication interface (for example, the communication interface 160) in a wireless or wired communication scheme.

When the download request is received, the display control module 230 may control a display module (for example, the display 150) to display a list of second applications which can be downloaded. Further, when an attribute of the second application corresponds to a first type (for example, a type including install data independent from the first application) and a request for executing the second application is received, the display control module 230 may control the electronic device (for example, the electronic device 101) to display a user interface for executing the second application on the display module.

The determination module 240 may determine the attribute of the second application selected by the user. The attribute of the second application may include one of a first type including install data independent from the first application, a second type, which is linked with the first application and may include install data dependent on the first application, and a third type which does not include install data.

The second application having the attribute of the first type may be, for example, an application including install data (for example, “.apk” of the Android™ operating system) independent from the first application. When the first application is a camera application for taking a picture, the second application may include, for example, a sequence shot mode or a light shot mode. The sequence shot mode may refer to a photography mode of successively photographing a moving subject in the same place, combining the photographed images into one image, and then providing the one image to a user. The light shot mode may refer to a photography mode of taking a picture by using a long exposure to represent a light trail in the picture. The term “independent” may mean that the second application includes install data which is distinguished from install data of the first application and can be executed alone. Thus, these modes alter the first applications ability to capture data.

The second application having the attribute of the second type may be, for example, an application including install data dependent on the first application. For example, the second application may perform an operation of processing an object pre-processed by the first application according to a request by the user. For example, the user may select an animated photo mode as the second application. An operation of pre-processing the taken picture may be performed by the first application to execute the animated photo mode. The pre-processing may be, for example, an operation of generating separate install data (for example, “apk”) for combined elements among elements included in a plurality of pictures in order to execute the animated photo mode. The second application may receive the pre-processed data (for example, separately generated data related to “apk”) from the first application and perform an operation according to a request by the user. Thus, these modes alter the ability of the of the first application to modify data captured by the first application

The second application having the attribute of the third type may be, for example, an application not including install data related to the first application. That is, the second application having the attribute of the third type may be an application which is loaded and executed according to a request by the user while the first application is being executed. For example, when the first application is a camera application, the second application having the attribute of the third type may be, for example, a golf shot mode or a High Dynamic Range (HDR) mode. The golf shot mode may be a function of acquiring movement of a subject according to a predetermined time interval to show one still image. These modes alter the first application to recognize and capture information from data captured by the first application.

According to various embodiments of the present disclosure, the function/functions or the operation/operations performed by the application management module 200 may be also performed by the processor (for example, the processor 120).

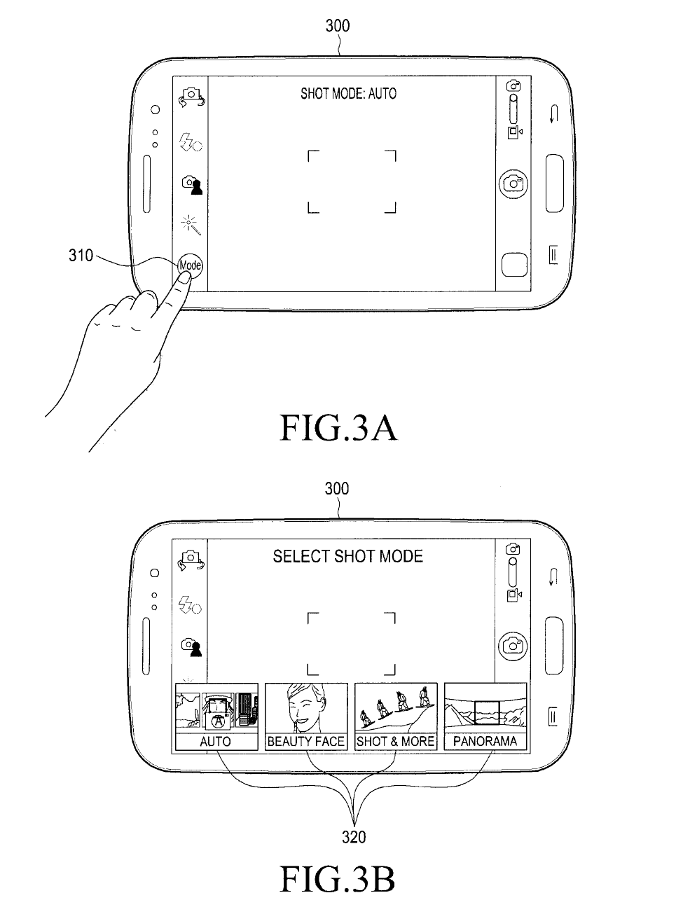

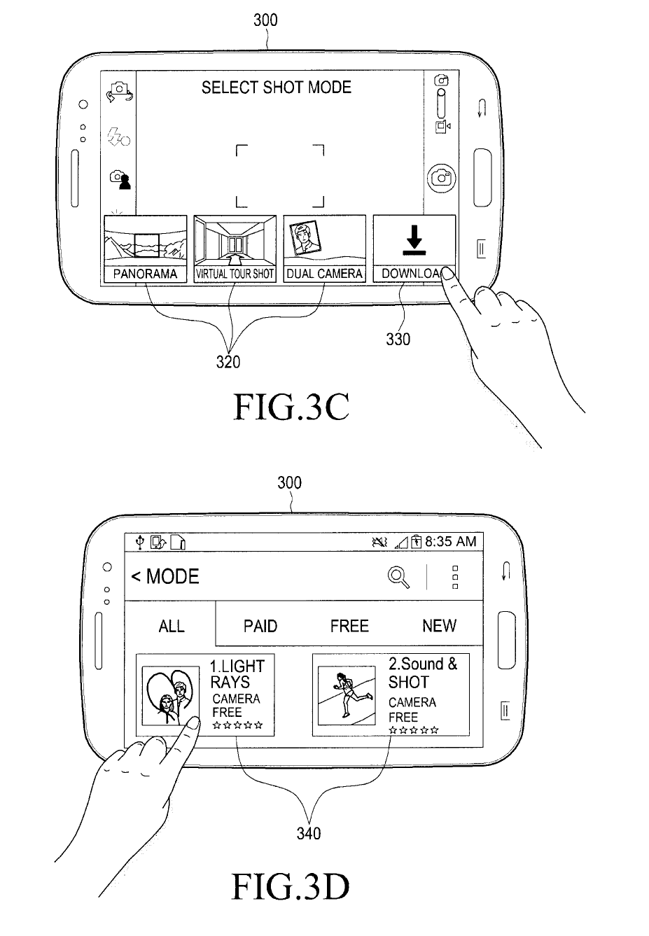

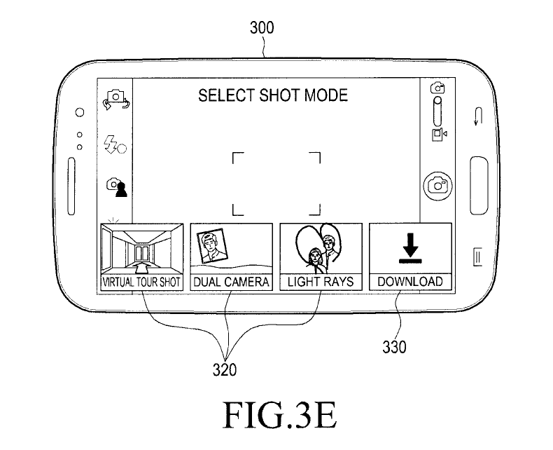

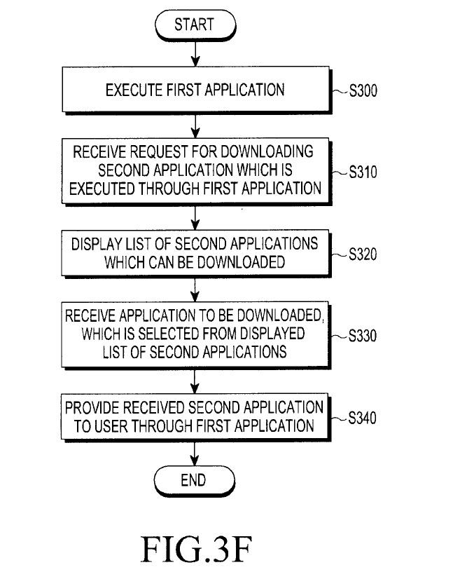

FIG. 3A to 3E illustrate an example operation of downloading a second application according to various embodiments of the present disclosure.

Referring to FIG. 3A, the user may input a request for executing a second application executed in connection with a first application (for example, a camera application) which is executed by an electronic device 300. The execution request may correspond to, for example, selecting a “mode icon 310”.

Referring to FIG. 3B, various second applications 320 which can be executed in connection with the first application may be displayed on the electronic device 300. The user may select a second application to be executed from the second applications displayed on the electronic device 300. When there is no second application which the user desires to execute in a list of the second applications, the user may input a request for downloading the second application which the user desires. According to an embodiment, the download request may be performed through the download icon 330, as illustrated in FIG. 3C.

When the download request is received from the user, the electronic device 300 may display the list of the second applications which can be downloaded, as illustrated in FIG. 3D. The list 340 of the second applications which can be downloaded may be received from another electronic device, for example, an application server (for example, the server 106) provided by, an application service provider. When the user selects a second application which the user desires from the displayed list 340, the electronic device 300 may download the selected second application and provide the downloaded second application, which may be displayed to the user within the first application, as illustrated in FIG. 3E. The second application may be, for example, a plug-in application.

FIG. 3F is a flowchart for one embodiment of the example operation as illustrated in FIGS. 3A to 3E.

Referring to FIG. 3F, the electronic device (for example, the electronic device 300) may execute a first application according to a request by the user in step S300 and receive a request for downloading a second application which is executed in connection with the first application in step S310. The electronic device may display a list of the second applications executable within the first application, which can be downloaded in step S320 and receive selection of an application to be executed, from the displayed list of the second applications in step S330. The electronic device may provide the received second application to the user by displaying a representation through the first application in step S340, where it can be executed. A detailed description of matters which have not been described in FIG. 3F will be omitted since the above description of the electronic device according to various embodiments of the present disclosure can be applied to the matters of FIG. 3F.

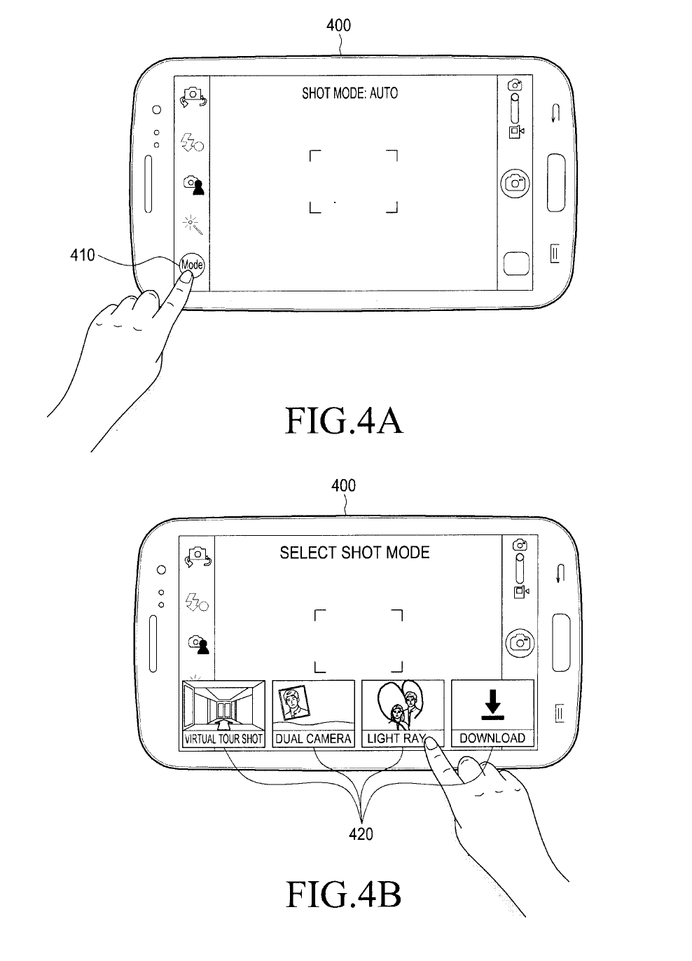

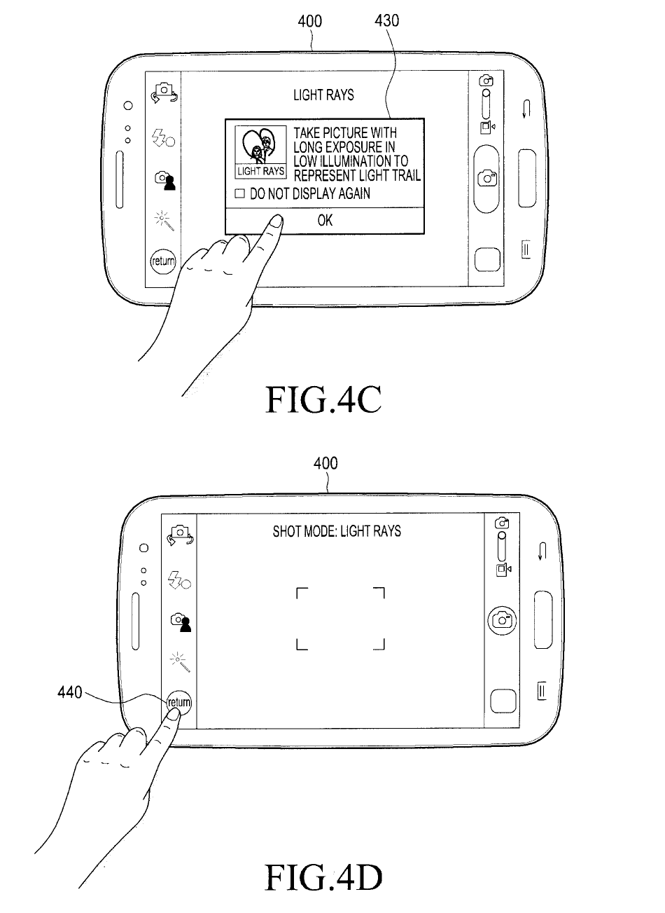

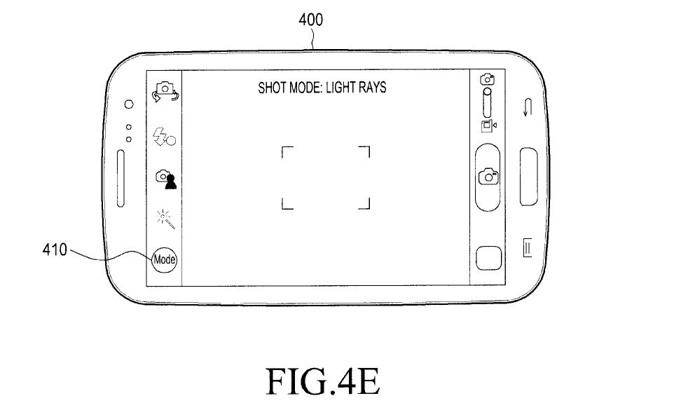

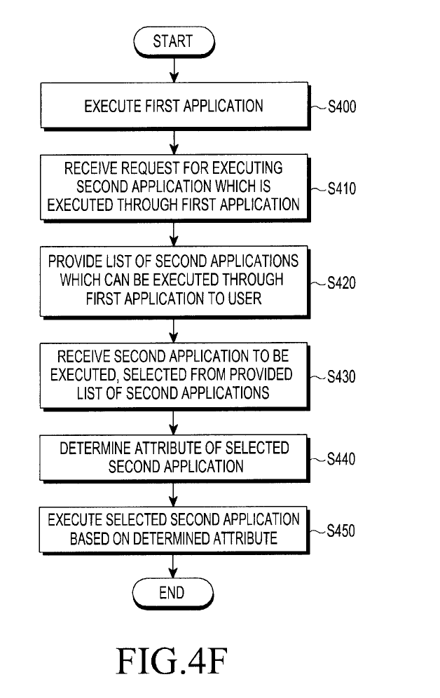

FIGS. 4A to 4E illustrate an example operation of executing a second application according to various embodiments of the present disclosure.

Referring to FIG. 4A, an electronic device 500 according to various embodiments of the present disclosure may receive a request for executing a second application which is executed in connection with a first application from the user. When the user selects, for example, a “mode” icon 510, the electronic device 500 may determine that a request for executing the second application is received from the user.

After receiving the request from the user, the electronic device 400 may display the downloaded application (with reference to FIGS. 3A to 3E). The “downloaded second application” described with reference to FIGS. 4A to 4E may be, for example, a first type application. That is, a “shot mode” corresponds to an application which may include install data independent from the camera application (the first application). The electronic device 400 may provide applications (for example, applications 420) related to the shot mode to the user through the first application (that is, together with the first application) as a User Interface (UI), as illustrated in FIG. 4B. Further, according to various embodiments of the present disclosure, the electronic device 400 may provide the second applications separately from the first application to the user as an independent UI. Although not illustrated, unlike the first type application, a second type application and a third type application do not include the independent install data, so that the second type application and the third type application can be provided to the user only through the first application. The electronic device 400 may receive an input of the downloaded second application selected by the user as illustrated in FIG. 4B.

When the input of the downloaded second application selected by the user is received, the electronic device 400 may execute the downloaded second application as illustrated in FIG. 4C. When a request for executing the downloaded second application is received from the user, the electronic device 400 may execute the first application again as illustrated in FIGS. 4D and 4E.

FIG. 4F is a flowchart for one embodiment of the example operation as illustrated in FIGS. 4A to 4E.

Referring to FIG. 4F, the electronic device 400 may execute a first application according to a request by the user in step S400 and receive a request for downloading a second application which is executed in connection with the first application in step S410. The electronic device 400 may provide a list of the second applications which can be executed through the first application to the user in step S420 and receive a second application selected to be executed in the provided list of the second applications in step S430. The electronic device 400 may determine an attribute of the selected second application in step S440 and execute the selected second application based on the determined attribute in step S450. The attribute of the second application which has been described in the specification may refer to the extent of independence with the first application. In other words, the second application having an attribute of the first type corresponds to the application that the extent of independence with the first application is the largest and the second application having an attribute of the third type corresponds to the application that the extent of independence with the first application is the smallest.

A detailed description of matters which have not been described in FIG. 4F will be omitted since the above description of the electronic device according to various embodiments of the present disclosure can be applied to the matters of FIG. 4F.

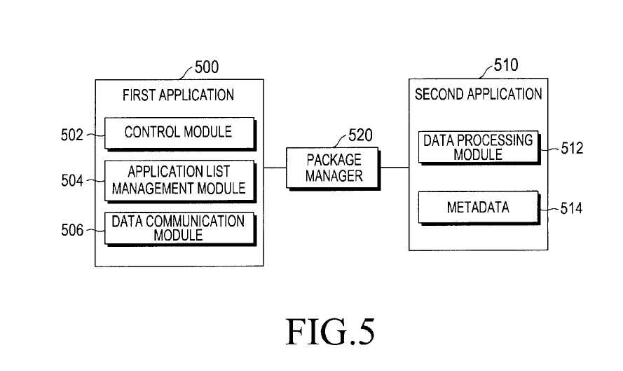

FIG. 5 is a block diagram illustrating an example first application and second application according to various embodiments of the present disclosure.

Referring to FIG. 5, a first application 500 and a second application 510 according to an embodiment of the present disclosure may be executed by, for example, the Android™ operating system. For example, the first application 500 may include a control module 502, an application list management module 504, and a data communication module 506. The second application 510 may include a data processing module 512 and metadata 514. The first application 500 and the second application 510 may be linked with each other by a package manager 520 to be executed.

Based on an input of the selected second application to be executed in the electronic device (for example, the electronic device 101), the control module 502 may make a control to execute the selected second application. The control module 502 may make a control to execute function/functions or operation/operations of the first application. For example, when the control module 502 is implemented through the Android™ operating system, the control module 502 may be implemented by activity to provide the first application 500 and/or the second application 510 to the user through a UI. The activity may refer to a UI component in the unit of screens provided to the user/users.

The application list management module 504 may receive information of application/applications (for example, list information of application/applications) which can be executed in the electronic device from the package manager 520. Further, the application list management module 504 may manage update information of the application/applications which can be executed in the electronic device and update the application/applications which can be executed in the electronic device. For example, when the application list management module 504 is implemented through the Android™ operating system, the application list management module 504 may be implemented through a component of the Android™ operating system, for example, a service or a broadcast receiver.

The data communication module 506 may transmit/receive various pieces of data between the first application 500 and the second application 510. For example, the data communication module 506 may transmit/receive data related to the pre-processed object.

The data processing module 512 may process (for example, pre-process) various pieces of data independently or according to a control by the control module 502. For example, when the application list management module 504 is implemented through the Android™ operating system, the data processing module 512 may be implemented through at least one component of the Android™ operating system (for example, an activity, a service, a broadcast receiver, or a content provider).

The metadata 514 may be metadata related to the second application. For example, the metadata 514 may include a title of the second application and an AIP version of the second application 510.

The package manager 520 may include information on the second application 510 installed in the electronic device.

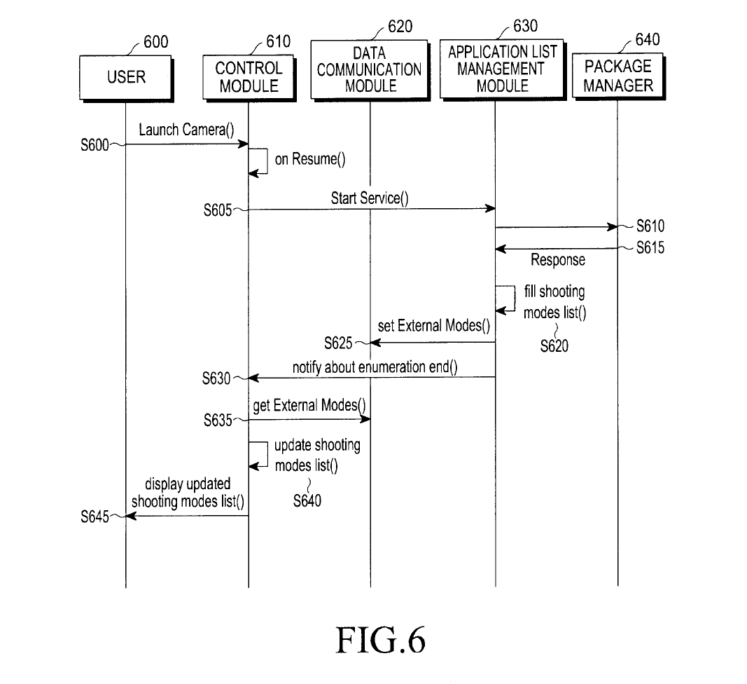

FIG. 6 illustrates example signal flow according to various embodiments of the present disclosure.

Referring to FIG. 6, a control module 610 may receive, for example, a request for executing a camera application from a user 600 in step S600. After receiving the request, the control module 610 may make a request for identifying whether a package manager 640 has an activity including an intent filter for a “CAMERA_SHOOTING_MODE” to an application list management module 630 in step S605. When the application list management module 630 receives the request from the control module 610, the application list management module 630 may transmit the request to the package manager 640 according to the request from the control module 610 in step S610, and receive a response to the request from the package manager 640 in step S615. The response may be a list of applications having the intent filter for the “CAMERA_SHOOTING_MODE”.

When the application list management module 630 receives the response, the application list management module 630 may check whether the list is effective. That is, the application list management module 630 may identify whether a shot mode/shot modes included in the received list are effective in step S620. The effectiveness may be identified through metadata of the second application, that is, an API version of the second application, a title of the second application, or a signature included in the second application. The effectiveness may refer to states that a specific application can be normally executed in a electronic device or an application which can be normally executed.

The application list management module 630 may store information of the shot mode/shot modes (that is, the second application) which have been determined as being effective based on the identification of the effectiveness in the data communication module 620 in step S625. Further, the application list management module 630 may notify the control module 610 of a list of the shot mode/shot modes which have been determined as being effective in step S630, and the control module 610 may acquire data of the shot mode/shot modes included in the notified list from, for example, a storage module (for example, the memory 130) or an application server (for example, the server 106) in step S635.

After acquiring data of the second applications (the shot mode/shot modes) included in the list, the control module 610 may update the list in step S640 and display the updated list in step S645.

In FIGS. 5 and 6, the method of controlling the electronic device according to various embodiments of the present disclosure based on the Android™ operating system has been described. However, function/functions or operation/operations implemented through the “Android™ operating system” in this specification are examples for describing the present disclosure. That is, an electronic device and a method of controlling the same according to various embodiments of the present disclosure can be applied to various OSs (for example, Samsung® Tizen™, Apple® iOS, and the like) as well as the aforementioned “Android™ operating system”.

Further, the present disclosure has been described to be implemented through the camera application as an example. An electronic device and a method of controlling the same according to various embodiments of the present disclosure can be applied between various main applications and a plug-in application for the main applications as well as the camera application.

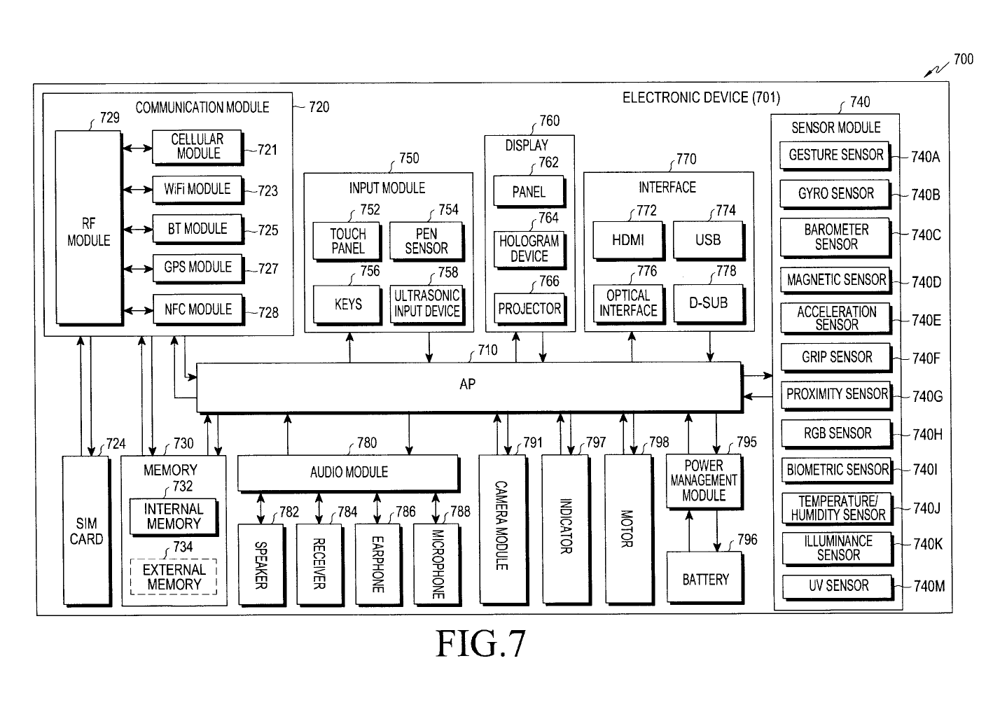

FIG. 7 is a block diagram illustrating an example electronic according to various embodiments of the present disclosure.

An electronic device 700 may include, for example, all or a part of the electronic device 101 shown in FIG. 1. Referring to FIG. 7, the electronic device 700 may include at least one application processor (AP) 710, a communication module 720, a Subscriber Identification Module (SIM) card 724, a memory 730, a sensor module 740, an input module 750, a display 760, an interface 770, an audio module 780, a camera module 791, a power management module 795, a battery 796, an indicator 797, and a motor 798.

The AP 710 may control a plurality of hardware or software components connected to the AP 710 by driving an operating system or an application program, process various data including multimedia data, and perform calculations. The AP 710 may be implemented by, for example, a System on Chip (SoC). According to an embodiment, the AP 710 may further include a Graphic Processing Unit (GPU).

The communication module 720 (for example, the communication interface 160) may perform data transmission/reception in communication between the electronic device 700 (for example, the electronic device 101) and other electronic devices (for example, the electronic device 104 or the server 106) connected thereto through a network. According to an embodiment, the communication module 720 may include a cellular module 721, a Wi-Fi module 723, a BT module 725, a GPS module 727, an NFC module 728, and a Radio Frequency (RF) module 729.

The cellular module 721 may provide a voice, a call, a video call, a Short Message Service (SMS), or an Internet service through a communication network (for example, Long Term Evolution (LTE), LTE-A, Code Division Multiple Access (CDMA), Wideband CDMA (WCDMA), UMTS, WiBro, GSM or the like). Also, the cellular module 721 may identify and authenticate an electronic device in a communication network using, for example, a subscriber identification module (for example, the SIM card 724). According to an embodiment, the cellular module 721 may perform at least some of the functions which can be provided by the AP 710. For example, the cellular module 721 may perform at least some of the multimedia control functions.

According to an embodiment, the cellular module 721 may include a Communication Processor (CP). Further, the cellular module 721 may be implemented by, for example, a SoC. Although the components such as the cellular module 721 (for example, the communication processor), the memory 730, and the power management module 795 are illustrated as components separated from the AP 710 in FIG. 7, the AP 710 may be implemented to include at least some of the above described components (for example, the cellular module 721) according to an embodiment.

According to an embodiment, the AP 710 or the cellular module 721 (for example, a communication processor) may load a command or data received from at least one of a non-volatile memory and other components connected to each of the AP 710 and the cellular module 721 to a volatile memory and process the loaded command or data. Further, the AP 710 or the cellular module 721 may store data received from or generated by at least one of the other components in a non-volatile memory.

Each of the Wi-Fi module 723, the BT module 725, the GPS module 727, and the NFC module 728 may include, for example, a processor for processing data transmitted/received through the corresponding module. Although the cellular module 721, the Wi-Fi module 723, the BT module 725, the GPS module 727, and the NFC module 728 are illustrated as individual blocks, at least a few (for example, two or more) of the cellular module 721, the Wi-Fi module 723, the BT module 725, the GPS module 727, and the NFC module 728 may be included in an Integrated Chip (IC) or an IC package. For example, at least a few (for example, a communication processor corresponding to the cellular module 721 and a Wi-Fi processor corresponding to the Wi-Fi module 723) of processors corresponding to the cellular module 721, the Wi-Fi module 723, the BT module 725, the GPS module 727, and the NFC module 728, respectively, may be implemented as a single SoC.

The RF module 729 may transmit/receive data, for example, an RF signal. Although not illustrated, the RF unit 729 may include, for example, a transceiver, a Power Amplifier Module (PAM), a frequency filter, a Low Noise Amplifier (LNA), or the like. Further, the RF module 729 may further include a component for transmitting/receiving electronic waves over a free air space in wireless communication, for example, a conductor, a conducting wire or the like. Although the cellular module 721, the Wi-Fi module 723, the BT module 725, the GPS module 727, and the NFC module 728 are illustrated to share one RF module 729 in FIG. 8, at least one of the cellular module 721, the Wi-Fi module 723, the BT module 725, the GPS module 727, or the NFC module 728 may transmit/receive the RF signal through a separate RF module.

The SIM card 724 may be a card including a subscriber identification module, and may be inserted into a slot formed in a particular portion of the electronic device. The SIM card 724 may include unique identification information (for example, Integrated Circuit Card IDentifier (ICCID)) or subscriber information (for example, International Mobile Subscriber Identity (IMSI)).

The memory 730 (for example, the memory 130) may include an internal memory 732 or an external memory 734. The internal memory 732 may include at least one of a volatile memory (for example, a Dynamic Random Access Memory (DRAM), a Static RAM (SRAM), a Synchronous Dynamic RAM (SDRAM), and the like) and a non-volatile memory (for example, a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a NAND flash memory, a NOR flash memory, and the like).

According to an embodiment of the present disclosure, the internal memory 732 may be a Solid State Drive (SSD). The external memory 734 may further include a flash drive, for example, a Compact Flash (CF), a Secure Digital (SD), a Micro Secure Digital (Micro-SD), a Mini Secure Digital (Mini-SD), an extreme Digital (xD), a memory stick or the like. The external memory 734 may be functionally connected to the electronic device 700 through various interfaces. According to an embodiment, the electronic device 700 may further include a storage device (or storage medium) such as a hard drive.

The sensor module 740 may measure a physical quantity or detect an operation state of the electronic device 700, and may convert the measured or detected information to an electrical signal. The sensor module 740 may include at least one of, for example, a gesture sensor 740A, a gyro sensor 740B, an atmospheric pressure sensor 740C, a magnetic sensor 740D, an acceleration sensor 740E, a grip sensor 740F, a proximity sensor 740G, a color sensor 740H (for example, a Red/Green/Blue (RGB) sensor), a bio-sensor 7401, a temperature/humidity sensor 740J, an illumination sensor 740K, or an Ultra Violet (UV) sensor 740M. Additionally or alternatively, the sensor module 740 may include, for example, an E-nose sensor (not illustrated), an ElectroMyoGraphy (EMG) sensor (not illustrated), an ElectroEncephaloGram (EEG) sensor (not illustrated), an ElectroCardioGram (ECG) sensor (not illustrated), an InfraRed (IR) sensor, an iris sensor (not illustrated), a fingerprint sensor (not illustrated) and the like. The sensor module 740 may further include a control circuit for controlling one or more sensors included therein.

The input device 750 may include a touch panel 752, a (digital) pen sensor 754, a key 756, or an ultrasonic input device 758. The touch panel 752 may recognize a touch input through at least one of, for example, a capacitive type, a resistive type, an infrared type, or an ultrasonic type. The touch panel 752 may further include a control circuit. The capacitive type touch panel may recognize physical contact or proximity. The touch panel 752 may further include a tactile layer. In this case, the touch panel 752 may provide a tactile reaction to a user.

The (digital) pen sensor 754 may be implemented, for example, using a method identical or similar to a method of receiving a touch input of a user, or using a separate recognition sheet. The key 756 may include, for example, a physical button, an optical key or a keypad. The ultrasonic input device 758 is a device which can detect an acoustic wave by a microphone (for example, microphone 788) of the electronic device 700 through an input tool generating an ultrasonic signal to identify data and can perform wireless recognition. According to an embodiment, the electronic device 700 may also receive a user input from an external device (for example, a computer or server) connected thereto, using the communication module 720.

The display 760 (for example, the display 150) may include a panel 762, a hologram device 764 or a projector 766. The panel 762 may be, for example, a Liquid Crystal Display (LCD), Active-Matrix Organic Light Emitting Diode (AM-OLED), or the like. The panel 762 may be implemented to be, for example, flexible, transparent, or wearable. The panel 762 may be also configured as one module together with the touch panel 752. The hologram 764 may show a stereoscopic image in the air by using interference of light. The projector 766 may project light onto a screen to display an image. The screen may be located, for example, inside or outside the electronic device 701. According to an embodiment, the display 760 may further include a control circuit for controlling the panel 762, the hologram device 764, or the projector 766.

The interface 770 may include, for example, a High-Definition Multimedia Interface (HDMI) 772, a Universal Serial Bus (USB) 774, an optical interface 776, or a D-subminiature (D-sub) 778. The interface 770 may be included in, for example, the communication interface 160 illustrated in FIG. 1. Additionally or alternatively, the interface 770 may include, for example, a Mobile High-definition Link (MHL) interface, a Secure Digital (SD) card/Multi-Media Card (MMC) interface, or an Infrared Data Association (IrDA) standard interface.

The audio module 780 may bidirectionally convert a sound and an electrical signal. At least some components of the audio module 780 may be included in, for example, the input/output interface 140 illustrated in FIG. 1. The audio module 780 may process sound information input or output through, for example, a speaker 782, a receiver 784, earphones 786, a microphone 788 or the like.

The camera module 791 is a device which can photograph a still image and a dynamic image. According to an embodiment, the camera module 791 may include one or more image sensors (for example, a front lens or a back lens), a lens (not shown), an Image Signal Processor (ISP) (not shown) or a flash (not shown) (for example, LED or xenon lamp).

The power management module 795 may manage power of the electronic device 700. Although not illustrated, the power management module 795 may include, for example, a Power Management Integrated Circuit (PMIC), a charger Integrated Circuit (IC), or a battery or fuel gauge.

The PMIC may be mounted to, for example, an integrated circuit or a SoC semiconductor. Charging methods may be classified into a wired charging method and a wireless charging method. The charger IC may charge a battery and prevent over voltage or over current from being flowed from a charger. According to an embodiment, the charger IC may include a charger IC for at least one of the wired charging method or the wireless charging method. A magnetic resonance scheme, a magnetic induction scheme, or an electromagnetic scheme may be exemplified as the wireless charging method, and an additional circuit for wireless charging, such as a coil loop circuit, a resonance circuit, a rectifier circuit, and the like may be added.

The battery gauge may measure, for example, the remaining amount of battery, a charging voltage and current, or temperature. The battery 796 may store or generate electricity, and may supply power to the electronic device 701 using the stored or generated electricity. The battery 796 may include, for example, a rechargeable battery or a solar battery.

The indicator 797 may indicate particular states (for example, a booting state, a message state, a charging state, etc.) of the electronic device 700 or a part (for example, the AP 710) of the electronic device 700. The motor 798 may convert an electrical signal into a mechanical vibration. Although not illustrated, the electronic device 700 may include a processing unit (for example, GPU) for mobile TV support. The processing unit for supporting the mobile TV may process media data according to a standard of Digital Multimedia Broadcasting (DMB), Digital Video Broadcasting (DVB), media flow or the like.

The above described components of the electronic device according to various embodiments of the present disclosure may be formed of one or more components, and a name of a corresponding component element may be changed based on the type of electronic device. The electronic device according to various embodiments of the present disclosure may be formed to include at least one of the above described components, and some of the components may be omitted or additional components may be further included. Also, some of the components of the electronic device according to the present disclosure may be combined to form a single entity, and thus may equivalently execute functions of the corresponding components before being combined.

The “module” used in various embodiments of the present disclosure may refer to, for example, a “unit” including one of hardware, software, and firmware, or a combination of two or more of the hardware, software, and firmware. The “module” may be interchangeable with a term, such as a unit, a logic, a logical block, a component, or a circuit. The “module” may be a minimum unit of an integrated component element or a part thereof. The “module” may be a minimum unit for performing one or more functions or a part thereof. The “module” may be mechanically or electronically implemented. For example, the “module” according to various embodiments of the present disclosure may include at least one of an Application-Specific Integrated Circuit (ASIC) chip, a Field-Programmable Gate Arrays (FPGAs), or a programmable-logic device for performing operations which have been known or are to be developed hereafter.

According to various embodiments, at least part of a device (for example, modules or functions thereof) or a method (for example, operations) according to the various embodiments of the present disclosure may be embodied by, for example, an instruction stored in a computer readable storage medium provided in a form of a programming module. When he command is executed by one or more processors (for example, the processor 120), the one or more processors may execute a function corresponding to the command. The computer-readable storage medium may be, for example, the memory 130. At least some of the programming modules may be implemented (for example, executed) by, for example, the processor. At least some of the programming modules may include, for example, a module, a program, a routine, or a set of instructions or a process for performing one or more functions.

The computer-readable recording medium may include magnetic media such as a hard disk, a floppy disk, and a magnetic tape, optical media such as a Compact Disc Read Only Memory (CD-ROM) and a Digital Versatile Disc (DVD), magneto-optical media such as a floptical disk, and hardware devices specially configured to store and perform a program instruction (for example, programming module), such as a Read Only Memory (ROM), a Random Access Memory (RAM), a flash memory and the like. In addition, the program instructions may include high class language codes, which can be executed in a computer by using an interpreter, as well as machine codes made by a compiler. The aforementioned hardware device may be configured to operate as one or more software modules in order to perform the operation of various embodiments of the present disclosure, and vice versa.

A module or a programming module according to the present disclosure may include at least one of the described component elements, a few of the component elements may be omitted, or additional component elements may be included. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added.

As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

In addition, an artisan understands and appreciates that a “processor” or “microprocessor” may include hardware. Under the broadest reasonable interpretation, the appended claims are statutory subject matter in compliance with 35 U.S.C. §101.

According to various embodiments, a storage medium that stores commands is provided. The commands are configured to allow one or more processors to perform one or more operations when the commands are executed by the one or more processors. The one or more operations may include an operation of executing a first application which is executed in the electronic device, an operation of receiving a request for downloading a second application which is executed in connection with the first application, and an operation of downloading the second application according to the request.

Further, the one or more operations may include an operation of executing the first application which is executed in the first electronic device, an operation of receiving a request for executing the second application which is executed in connection with the first application, an operation of determining an attribute of the selected second application, and an operation of executing the selected second application based on the determined attribute.

Embodiments of the present disclosure provided in the present specifications and drawings are merely certain examples to readily describe the technology associated with embodiments of the present disclosure and to help understanding of the embodiments of the present disclosure, but may not limit the ambit of the embodiments of the present disclosure. Therefore, in addition to the embodiments disclosed herein, the ambit of the various embodiments of the present disclosure should be construed to include all modifications or modified forms drawn based on the technical idea of the various embodiments of the present disclosure.

What is claimed is:

1. A method of controlling an electronic device, the method comprising:
executing a first application by a processor of the electronic device;
receiving a request for downloading a secondary application augmenting execution of the first application; and
downloading the secondary application according to the request.

2. The method of claim 1, wherein the secondary application augments the first application by at least one of:
altering data capture by the first application;
modes adding post-processing functions for data already captured by the first application; and
modes adding information recognition and capture for data already captured by the first application.

3. The method of claim 1, further comprising:
in response to receiving the request, displaying a list of secondary applications which can be downloaded.

4. A method of controlling an electronic device, the method comprising:
executing a first application by a process of the electronic device;
receiving a request for executing a second application executed in connection with the first application;
detecting an attribute of a selected second application; and
executing the selected second application based on the detected attribute.

5. The method of claim 4, wherein the second application is a plug-in application for the first application.

6. The method of claim 4, further comprising providing a user with a list of second applications executable through the first application.

7. The method of claim 4, wherein the attribute of the second application includes one of a first type including install data which is independent from the first application, a second type including install data which is linked with the first application and dependent on the first application, and a third type which does not include the install data.

8. The method of claim 7, further comprising, when the attribute of the second application corresponds to the first type and a request for executing the second application is received, modifying a User Interface (UI) of the first application to include elements selectable to execute the second application.

9. The method of claim 7, further comprising, when the attribute of the second application corresponds to the second type and a request for executing the second application is received,
performing predetermined pre-processing on an object executed through the first application; and
executing the pre-processed object through the second application.

10. The method of claim 7, further comprising, when the attribute of the second application corresponds to the third type and a request for executing the second application is received, loading the second application through the first application being executed.

11. An electronic device comprising:
a display;
a camera; and
a processor, configured to:
execute a camera application operating the camera and displaying a graphical user interface controlling the camera application on the display;
displaying in the graphical user interface a plurality of selectable modes augmenting the camera application;
in response to an input, downloading an additional selectable mode augmenting the camera application; and
when the additional selectable mode is downloaded, displaying in the graphical user interface the additional selectable mode.

12. The electronic device of claim 11, wherein the plurality of selectable modes augment the camera application by at least one of
altering image capture by the camera;
post-processing one or more images captured by the camera; and
recognizing and capturing information utilizing images captured by the camera.

13. The electronic device of claim 11, wherein in response to the input, a list of downloadable additional selectable modes is displayed within the graphical user interface of the camera application.

14. An electronic device comprising:
a processor for:
executing a first application by a process of the electronic device;
receiving a request for executing a second application executed in connection with the first application;
detecting an attribute of a selected second application; and
executing the selected second application based on the detected attribute.

15. The electronic device of claim 14, wherein the second application is a plug-in application for the first application.

16. The electronic device of claim 14, wherein the processor displays a list of second applications which can be executed through the first application while the first application is executed.

17. The electronic device of claim 14, wherein the second application includes one of a first type including install data which is independent from the first application, a second type including install data which is linked with the first application and dependent on the first application, and a third type which does not include the install data.

18. The electronic device of claim 17, wherein, when the second application corresponds to the first type and a request for executing the second application is received, the processor modifies a User Interface (UI) of the first application to include elements selectable to execute the second application.

19. The electronic device of claim 17, wherein, when the attribute of the second application corresponds to the second type and a request for executing the second application is received, the processor performs predetermined pre-processing on an object executed through the first application and makes a control to execute the pre-processed object through the second application.

20. The electronic device of claim 17, wherein, when the attribute of the second application corresponds to the third type and a request for executing the second application is received, the processor makes a control to load the second application through the first application being executed.
